(19) United States
(12) Patent Application Publication
(10) Pub. No.: US 2019/0270423 A1
(43) Pub. Date: Sep. 5, 2019

(54) Bicycle Carrier Mountable on a Vehicle Push Bumper

(71) Applicant: Marcus Hutton, East St. Paul (CA)

(72) Inventor: Marcus Hutton, East St. Paul (CA)

(21) Appl. No.: 16/292,641

(22) Filed: Mar. 5, 2019

Related U.S. Application Data
(60) Provisional application No. 62/638,696, filed on Mar. 5, 2018.

(51) Int. Cl. B60R 19/48; B60R 9/06; B60R 9/10

(52) U.S. Cl. CPC B60R 19/48; B60R 9/10; B60R 9/06

(57) ABSTRACT

A bicycle carrier mounted to, or configured for mounting to, a push bumper of a police cruiser or other similarly equipped vehicle. In select embodiments, the bicycle carrier is removably mountable to the push bar, allowing storage of the bicycle carrier in the vehicle trunk between uses.

### CROSS-REFERENCE TO RELATED APPLICATIONS

This application claims benefit under 35 U.S.C. 119(e) of U.S. Provisional Application No. 62/638,696, filed Mar. 5, 2018, the entirety of which is incorporated herein by reference.

### FIELD OF THE INVENTION

The present invention relates generally to vehicle mounted bicycle carriers.

### BACKGROUND

Bicycle carriers of a variety of styles are commercially available for conventional passenger cars, and include hitch-mounted bicycle carriers, trunk-mounted bicycle carriers and roof-mounted bicycle carriers. While suitable for conventional passenger vehicles used by the general public, these conventional bicycle carriers are not particularly suited to use on emergency vehicles, for example police cruisers where trunk or hitch mounted bicycle carriers might interfere with unobstructed access to trunk-carried equipment, and where roof-mounted emergency beacons prevent installation of a roof-mounted bicycle carrier. At the same time, it would be useful for a police vehicle to be equipped with a bicycle carrier, for example to transport a recovered bicycle that has been lost, stolen or involved in an accident, or to transport the bicycle of a suspect, witness, bicycle patrol or other passenger currently occupying the police vehicle.

Accordingly, there is a need for a bicycle carrier solution particularly suited for police vehicles or other comparably equipped vehicles.

### SUMMARY OF THE INVENTION

According to a first aspect of the invention, there is provided a bicycle carrier that configured for mounting on a push bumper of a vehicle.

According to a second aspect of the invention, a vehicle push bumper has a bicycle carrier supported thereon to indirectly support said bicycle carrier on a vehicle.

According to a third aspect of the invention, a method of installing a bicycle carrier on a vehicle comprises mounting said bicycle carrier to a push bumper of said vehicle.

According to a fourth aspect of the invention, a bicycle carrier is provided in combination a vehicle having a push bumper mounted thereon, said bicycle carrier being installed on said push bumper, thereby indirectly supporting the bicycle carrier on said vehicle.

Police vehicles are often equipped with a push bumper at the front end of the vehicle. The push bumper, also known as a push bar or grille guard, is a piece of aftermarket hardware added to a factory vehicle to protect the factory bumper and grille against damage in the event that the police vehicle is used to push a disabled vehicle from a roadway, nudge a fleeing vehicle in an attempt to slow or spin same, or perform another strategic technique involving contact with another vehicle or object at the police vehicle's front end. The push bumper is also sometimes used to house equipment such as sirens, beacons, lights, etc. Using the existing push bumper as a mounting point for a bicycle carrier means that installation of bicycle carrier doesn't require any further modification to the vehicle itself, doesn't rely on the presence of a trailer hitch receiver, doesn't interfere with full and readily available trunk access, and doesn't require rooftop installation that might be prevented by, or interfere with, rooftop emergency beacons.

### BRIEF DESCRIPTION OF THE DRAWINGS

Preferred embodiments of the invention will now be described in conjunction with the accompanying drawings in which:

FIG. 1 illustrates an example of a known push bumper mounted to the front end of a police car or other vehicle.

FIG. 2 is a perspective view of a first embodiment bicycle carrier of the present invention configured for removable mounting to a push bumper.

FIG. 3 shows the bicycle carrier of FIG. 2 in an installed position on the push bumper of a vehicle, with the push bumper cross-sectioned in a vertical plane.

FIG. 4 illustrates a second embodiment bicycle carrier according to the present invention.

### DETAILED DESCRIPTION

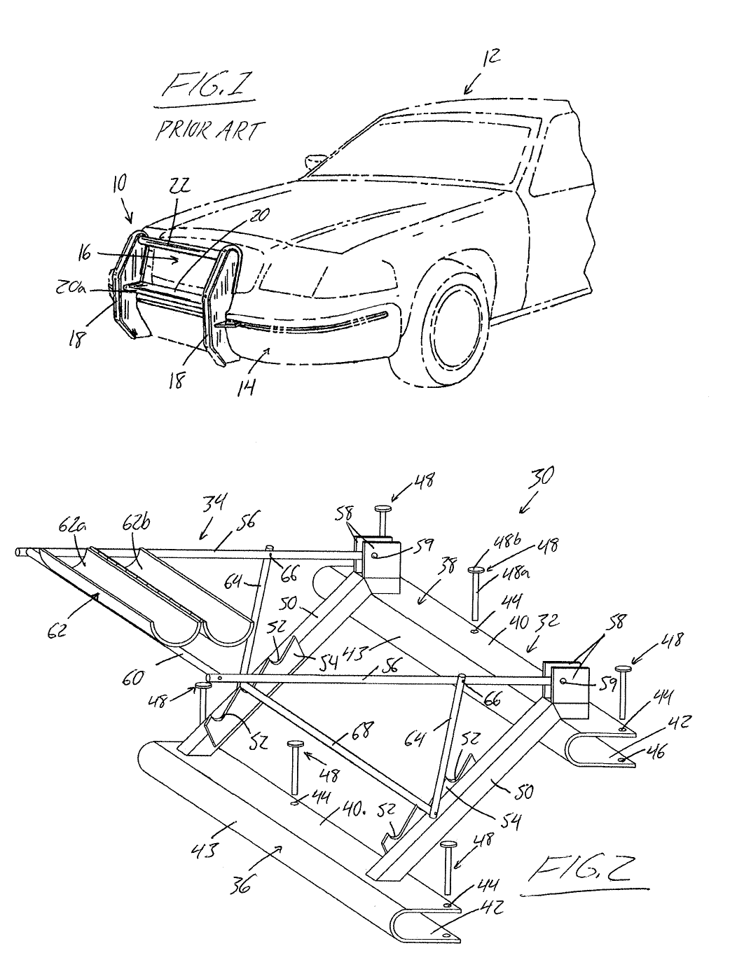

FIG. 1 illustrates a conventional push bumper 10 mounted to the front end of a police vehicle 12 for the purpose of protecting the factory bumper 14 and grille 16 thereof. In a known manner, the push bumper features an H-frame that is mounted to the vehicle in a position residing in front of the factory bumper and grille. This H-frame features two upright push members 18 spanning upwardly from the bottom of the factory bumper 14 to near the top of the grille 16 in positions generally aligned with opposing sides of the grille. A lower cross-bar 20 completes the H-frame by spanning horizontally in a transverse lateral direction of the vehicle between the upright push members 18 at a generally central elevation thereon near the bottom of the grille 16 and the top of the factory bumper 14. In addition to this main H-frame, the push bumper 10 features an upper cross-bar 22 that spans horizontally between the upright push members 18 in parallel relation to the lower cross-bar 20 in a spaced elevation thereabove near the top of the grille 16.

To generally follow the profile of the vehicle's front end, the upright push members 18 typically have a rearward incline at their upper halves, thereby sloping rearwardly from the forwardly protrusive factory bumper to more closely follow the rearward incline of the vehicle's grille profile. Attached near the top ends of the upright push members 18, the upper cross-bar 22 is typically situated in rearwardly offset relation to the front edge 20a of the lower cross-bar 20. As shown, the lower cross-bar 20 is typically a piece of rectangular metal tubing of elongated rectangular cross section that gives the lower cross-bar 20 a greater front-to-back width in the longitudinal direction of the vehicle than the upper cross-bar, which is typically a piece of round metal tubing.

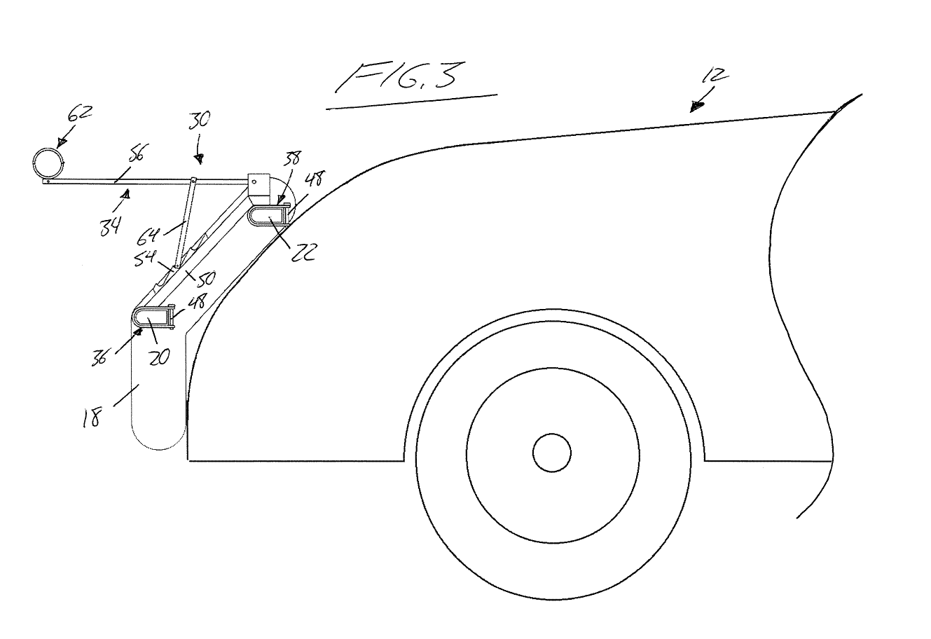

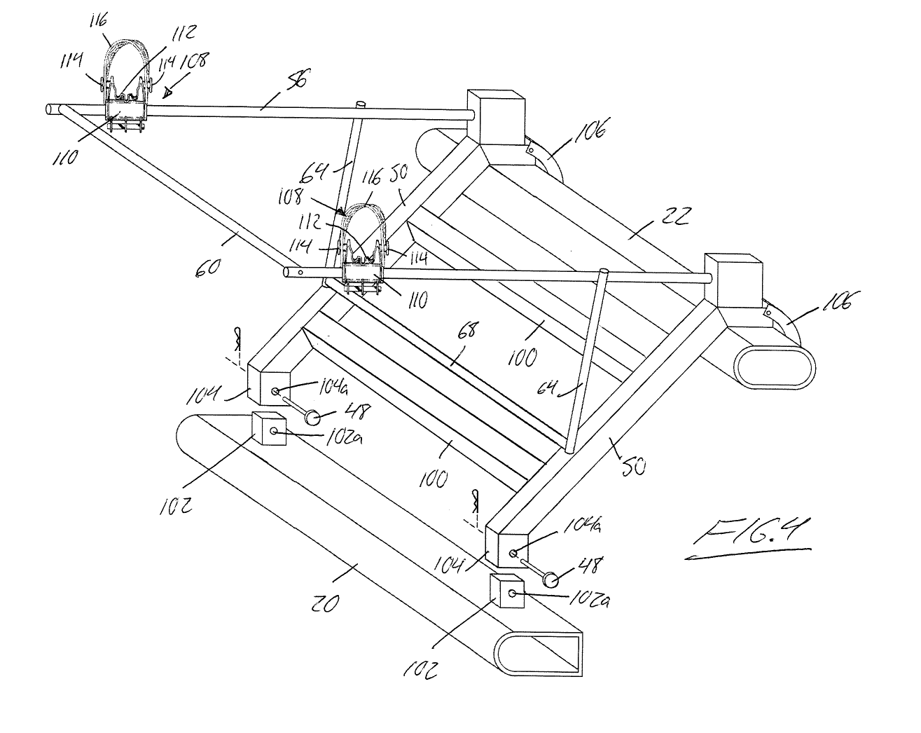

FIG. 2 illustrates a bicycle carrier 30 of the present invention, which has been designed for mounting to the police vehicle 12 in an indirect manner via attachment to the previously installed push bumper 10, thereby providing an alternative to hitch-mounted, trunk-mounted and roof-mounted bicycle carriers of the type typically employed by the general public on standard non-service passenger vehicles.

The bicycle carrier 30 of the first illustrated embodiment features a stationary mounting frame 32 by which the attachment to the push bumper 10 is made, and a movable carrier frame 34 pivotably supported on the mounting frame 32 for movement between a deployed working state operable to carry a bicycle thereon, and collapsed storage state reducing or eliminating its degree of forward protrusion from the mounting frame 32 and underlying push bumper 10.

The mounting frame 32 features a lower mount 36 for attachment to the lower cross-bar 20 of the push bumper 10, and an upper mount 38 for attachment to the upper cross-bar 22 of the push member 10. In the first illustrated embodiment, each mount 36, 38 is a length of U-shaped metal channel oriented in a rearwardly-opening position so that top and bottom legs 40, 42 of the channel's U-shaped cross section can be slid rearwardly over the topside and underside of the respective cross-bar of the push bumper. Such sliding action places the mount 36, 38 into a mated position with the respective cross-bar 20, 22 so that the cross-bar is received inside the metal channel, while the closed front end 43 of the channel embraces over the front edge of the cross-bar 20, 22.

In the first illustrated embodiment, each mount 36, 38 features a respective coupling mechanism by which the mount can be temporarily secured to the respective cross-bar 20, 22 of the push bumper 10 in a removable manner. In the first illustrated example, the upper coupling mechanism at the upper mount and the lower coupling mechanism at the lower mount are of the same design, each featuring multiple pin-holes arranged in aligned pairs in the top and bottom legs of the metal channel. A respective lock pin can be inserted through each aligned pair of pin-holes to prevent the channel-shaped mount 36, 38 from sliding forwardly off the respective cross-bar 20, 22 of the push bumper 10. Each pair of pin holes features an upper hole 44 in the top leg of the channel and a lower hole 46 that is situated in the lower leg of the channel in aligned relationship with the upper hole 44. Each locking pin 48 has a shaft 48a of small enough diameter to be lowerable through the respective pair of pin holes 44, 46, and an enlarged head 48b exceeding the pin hole diameter so as to rest atop the channel shaped mount 36, 38 at the top leg 40 thereof. Such resting of the lock pin head 48b atop the mount 36, 38 defines the fully inserted pin position by which the mount 36, 38 is effectively locked to the respective push bumper cross-bar 20, 22.

The channel legs 40, 42 of the upper mount 38 may reach rearwardly beyond the rear side of the push bumper's upper cross-bar 22 so that the respective upper set of lock pins engage through the upper mount 38 behind the push bumper's upper cross-bar 22 to block the upper mount 38 from sliding forwardly off of the push bumper 10. Since the lower mount 36 embraces the wider lower cross-bar 20 of the push bumper 10, and thus may not be able to reach behind this lower-cross-bar due to close positioning thereof to the vehicle's factory bumper 14, insertion of the lower set of lock pins through the lower mount 36 may require drilling of matching vertical pin holes through the push bumper's lower cross-bar 20 at equally spaced intervals to the pin hole pairs 44, 46 in the lower mount 36 of the bicycle carrier 30. In such instance, the lower set of lock pins are inserted through the lower cross-bar 20 of the push bumper to lock the lower mount 36 thereto. Each coupling mechanism of the illustrated embodiment employs three lock pin locations, specifically two lock pin locations that are respectively disposed near the ends of the mount 36, 38, and a central pin location at a general mid-point of the mount's length. However, it will be appreciated that pinned connections just at the ends of the mount may be sufficient.

Disconnectable coupling mechanisms other than removable pin connections may alternatively be employed to temporarily secure the mounts of the bicycle carrier 30 to the cross-bars 20, 22 of the push bumper 10. In another embodiment, the mounts 36, 38 of the bicycle carrier 30 may be permanently attached to the push bumper 10, for example by welding. However, removable installation is preferred so that the push bumper 10 can be used in a conventional manner in the absence of the bicycle carrier 30 when transport of a bicycle is not required, whereby damage to the unloaded bicycle carrier 30 during push-bumper use is avoided.

The mounting frame 32 features two parallel, horizontally-spaced side members 50 spanning upwardly from the lower mount 36 to the upper mount 38 at a rearwardly inclined angle so as to support the upper mount 38 in rearwardly offset relation to the lower mount 36 by the same upward and rearward distance by which the upper cross-bar 22 of the push bumper 10 is offset from the lower cross-bar 20 thereof. The length of each mount 36, 38 measured between its opposing ends is slightly less than the cross-bar lengths of the push bumper 10 so that the entirety of the mounting frame 32 resides between the two upright push members 18 of the push bumper 10 when the bicycle carrier 30 is mounted thereon. Each side member 50 is attached to the two mounts 36, 38 near a respective end thereof, so as to reside adjacent a respective one of the upright push members 18 of the push bumper 10 when the mounting frame 32 is mounted thereon.

Each side member 50 carries a set of support seats 52 arranged in series in positions of increased elevation along the upwardly inclined length of the side member 50 from near the lower mount 36 toward the upper mount 38. In the illustrated embodiment, the support seats 52 are defined by notches into which a cross-bar of a brace arrangement of the carrier frame can be received to support the carrier frame in the deployed state. In the first illustrated embodiment, each side member 50 is a length of metal tubing to which a notched side-plate 54 is affixed, for example by welding, to an inner side of the side member 50 that faces the other side member 50. The side plate 54 is taller than the side member 50 so that the notched top edge of the side plate resides above the side member 50. The support seats 52 notched into the top edge of the side plate 54 are thus situated shortly above the topside of the respective side member 50.

In other embodiments, each side member 50 may be a flat bar that is affixed to the mounts 36, 38 in an edge-wise up orientation with the support seats directly notched in this upwardly facing top edge of the bar. Each notch has a concavely rounded bottom into which the cross-bar of the carrier frame's bracing arrangement is received. From this concave bottom, the top edge of the notched bar or side plate 54 angles upwardly at a greater slope than the axis on which the overall side member 50 angles upwardly and rearwardly from the lower mount 36 to the upper mount 38, thus giving the bar or side plate 54 a rack-like shape having pointed teeth or peaks, each of which is neighboured to the top-rear side thereof by the curved-cradle like bottom of the next support seat 52.

The carrier frame 34 is movably supported on the mounting frame 32, and is the part of the bicycle carrier from which a bicycle can be hung when the carrier frame 34 is in its deployed working state. The carrier frame features two arms 56 pivotally carried on the mounting frame 32 at the upper mount 38 thereof. Each arm 56 is pivotally supported between a pair of lugs 58 that stand upwardly from the topside of the upper mount 38 at or adjacent the upper end of a respective one of the mounting frame's side members 50. A respective horizontal pivot pin 59 passes through each pair of lugs 58 in the length direction of the upper mount (i.e. the transverse lateral direction of the vehicle) to carry the respective arm 56 in a manner pivotable upwardly and downwardly about the horizontal pivot axis shared by the two pivot pins 59. The carrier frame 34 can thus pivot upwardly and downwardly away from and back toward the inclined plane occupied by the mounting frame's side members 50. A distal member 60 spans horizontally and perpendicularly between the two arms 56 at or near the distal ends thereof furthest from their pivotable connection to the upper mount 38, and thus lies parallel to the mounts 36, 38 of the mounting frame 32. A bicycle holder 62 is mounted on this distal member 60 and is operable to clamp onto the frame of a bicycle.

In the first illustrated embodiment, the bicycle holder is an elongate clam-shell holding clamp having two hinged-together semi-cylindrical shells 62a, 62b whose axes lie parallel to the distal member 60 on which one of said shells is mounted. The shells 62a, 62b can be selectively closed together around the top tube of a bicycle, and locked in this closed position to secure the bicycle frame's top tube within the holding clamp 62. The arms 36 of the carrier frame are long enough to reach forwardly past the vertical plane occupied by the front end of the mounting frame's lower mount 36 when the carrier frame is in the deployed working state. Accordingly, with the top tube of a bicycle frame secured inside the holding clamp 62, the bicycle is hung from the distal end of the carrier frame 34 at a location spaced slightly forwardly from the lower mount 36, thus carrying the bicycle in cantilevered fashion in a vertical plane spaced in in front of the lower cross-bar 20 and upright push members 18 of the push bumper 10. Other styles of clamps, clips or other releasable holders may alternatively be used on the carrier frame 34 to hang the bicycle frame therefrom. One such clamping option may employ two separate clamps, clips or cradles, either mounted at spaced apart positions along distal member 60, or respectively mounted directly on the arms 56 of the carrier frame.

The bracing arrangement by which the carrier frame is held up on the support seats 52 features a respective bracing member 64 coupled to each arm 56 at a pivot point 66 located intermediately between the pivotally pinned proximal end of the arm 56 and the opposing distal end thereof that can be swung upwardly and downwardly about the horizontal pivot axis of the pivot pins 59. The pivot points 66 at which the bracing member 64 are pivotably coupled to the arms 56 share a common horizontal pivot axis that lies parallel to that of the pivot pins 59 by which the overall carrier frame 34 is movably supported on the mounting frame. The cross-member 68 of the bracing arrangement spans horizontally and perpendicularly between the bracing members 64 at free ends thereof furthest from the pivot points 66, and lies parallel to the clamp-carrying distal member 60 of the carrier frame 34. The support seats 52 on each side member 50 of the mounting frame 32 each align with a respective one of the support seats 52 on the other side member 50. The horizontal length of the cross-member 68 of the bracing arrangement exceeds the horizontal distance between the notched bars or side plates 54 of the mounting frame 32, such that the cross-member 68 can engage both sets of support seats 52 and thus be rested in the concave bottoms of any selected pair of aligned support seats.

The first illustrated embodiment features three pairs of aligned support seats, and FIG. 2 shows the cross-member 68 seated in the middle pair of support seats. This holds the carrier frame 34 at an intermediate angle of deployment placing the distal end of the carrier frame 34 at an intermediate elevation, for example corresponding to a horizontal orientation of the arms 56. Lifting the cross-member 68 of the bracing arrangement out of the middle pair of support seats 52 pivots the carrier frame 34 upwardly about the shared axis of the pivot pins 59, whereupon seating of the cross-bar 68 into the higher pair of aligned support seats will hold the carrier frame 34 at an increased angle of deployment, thus placing the distal end of the carrier frame at an increased elevation, for example with the arms at a forwardly inclining orientation. Likewise, upward withdrawal of the cross-member 68 out of the middle or upper pair of support seats 52, followed by downward pivoting the carrier frame 34 about the shared axis of pivot pins 59, allows the cross-member 68 to be lowered down into the lower pair of support seats, whereby the bracing members 64 will hold the carrier frame 34 at a reduced angle of deployment, thus placing the distal end of the carrier frame 34 at a reduced elevation, for example with the arms at a forwardly declining orientation.

Accordingly, the particular deployment angle of the carrier frame 34 and the resulting height at which the bicycle holder 62 at the distal end of the carrier frame 34 is supported can be adjusted by selecting from among the different support seats 52. Depending on the vehicle profile, and the elevation of the push bumper dictated by said vehicle profile, the carrier frame 34 of the bicycle carrier 30 can be set to a sufficient height necessary to suspend the bicycle off the ground, while minimizing the potential obstruction of the vehicle operator's forward sight line over the hood of the vehicle.

For a small bike or taller vehicle profile, the lowest pair of support seats can be selected to establish a minimum angle of the carrier frame and resulting minimum deployed elevation of the bicycle holder 62, while still leaving ground clearance for the bicycle tires. For a larger bike or shorter vehicle profile, the highest pair of support seats can be selected to establish a maximum deployed angle of the carrier frame and resulting maximum deployed elevation of the bicycle holder, thereby establishing sufficient ground clearance for the bicycle tires. If the bicycle carrier 30 is left in place on the push bumper 10 even when transport of a bicycle is unnecessary, then the bracing arrangement can be folded up against the underside of the carrier frame, whereupon the folded-together carrier frame and bracing arrangement can be laid atop the side members 50 of the mounting frame 32. This establishes a collapsed storage state in which the carrier frame 34 lies closely adjacent and generally parallel to the mounting frame 32, unlike in the deployed working state shown in FIG. 2, where the carrier frame 34 is at an oblique angle to the mounting frame 32 to reach forwardlky therefrom and maintain an elevated state of the bicycle holder 62 in front of the push bumper 10.

The carrier frame in the first illustrated embodiment is thus raisable and lowerable between a collapsed storage state and a deployed working state, and due to the inclusion of multiple support seats 52, is also adjustable to select from among different elevational positions within said working state, thereby providing the most user flexibility. However, other embodiments may employ a fixed carrier frame that projects forwardly out from the mounting frame at a non-adjustable angle thereto. Such embodiments may lack a height adjustment mechanism of any kind, for example for use on trucks or sport utility vehicles of notable ground clearance sufficient to suspend even relatively large bikes off the ground. Alternatively, fixed angle embodiments may employ an alternate height adjustment mechanism, for example having the clamp or other bicycle holder 62 adjustably mounted at or near the distal end of the fixed-angle carrier frame 34 for height-adjustment thereon.

In another embodiment, the carrier frame is movable between the deployed working state and collapsed storage state, but lacks angle/height adjustability within the deployed working state, for example having only one set of support seats 52 in which the bracing arrangement can be engaged. It will also be appreciated that angle/height adjustment mechanisms other than the described cooperation between a bracing arrangement and rack-like set of support seats 52 may be used for adjustment of the deployed working state. One alternative example uses lock pins engageable through the arms of the carrier frame via arcuate arrays of lock holes centered around the pivot axis of the arms to lock same at different selected angles. Regardless of whether height/angle adjustability in the deployed working state is included, selective collapse of the carrier frame into the storage position is particularly useful in embodiments that are removably mounted to the push bumper, as it enables convenient collapse of the bicycle carrier to a reduced footprint that is more easily and conveniently stored, for example in the trunk, hatch, cargo bed or other cargo space of the vehicle, between uses. On the other hand, even embodiments of fixed non-collapsible shape and size may nonetheless be sufficiently small for storage in the trunk of the vehicle during periods of non-use.

While the first illustrated embodiment uses a mounting frame that engages both cross-bars of the push bumper, other embodiments may be capable of supporting the deployed carrier frame solely from either one of the two cross-bars, or may employ an alternate design mounted to one or both of the upright push members 18 of the push bumper. However, the multi-bar mounting configuration of the first illustrated embodiment provides sturdy, robust support, and uses the side members that join the upper and lower mounts together for the secondary purpose of supporting the height/angle adjustment support seats. While the illustrated embodiment uses two such side members to interconnect the two mounts, and a pair of rack-like bars/plates to define the support seats, other embodiments may employ a singular member spanning between the two mounts, for example at the center points thereof, Likewise, the carrier frame may employ a simplified single-arm construction, provided the single arm is capable of supporting the cantilevered weight of the suspended bicycle thereon.

It will therefore be appreciated that the term “frame” does not necessarily denote a multi-component structure, and that the, as the mounting frame may be as simple as a member arm suitably equipped with a mounting feature at one or both of its upper and lower ends by which it is mountable to one or both cross-bars of the push bumper, and the carrier frame may likewise be as simple as a singular arm having a proximal end carried by the mounting frame and reaching forwardly therefrom to support a bicycle thereon.

In another embodiment, the open-channel slide-on mounts for slipping over the cross-members of the push bumper may be omitted altogether, and the side members 50 may be directly attached to the cross-members of the push bumper at the top and bottom ends of the side members, for example using removable bolts to create detachable upper and lower mounts, or using welded connections to create permanent mounts.

FIG. 4 shows an example of one embodiment omitting the open-channel slide-on mounts of the first illustrated embodiment, and instead employing a fixed-position carrier frame that is neither adjustable in height nor collapsible into a more compact storage state. In this second illustrated embodiment, the mounting frame against features a pair of horizontally spaced side members 50 for spanning between releasable connections to the upper and lower cross bars of the push member. However, since this embodiment omits the channel-shaped mounting members of the first embodiment, the side members are instead interconnected by one or more cross-members 100 at one or more locations situated intermediately between the top and bottom ends of the side members.

The carrier frame once again features two arms 56 coupled to the mounting frame near the top ends of the side members to reach forwardly therefrom, but this time features fixed attachment to the side members 50 rather than a movable pivot connection thereto. Bracing members 64 are once again attached to the arms 56 at locations situated forwardly from the proximal ends thereof, but this time are fixedly attached to the arms 56 and to the side members to form a stationary bracing arrangement of the fixed-position carrier frame of this embodiment. Though the drawing shows a cross-member 68 once again coupled between the bracing members 64, it will be appreciated that this may be omitted.

In the FIG. 4 embodiment, releasable attachment of the mounting frame to the lower cross-bar of the push bumper employs a pair of first lower mounting components 102 attached to the lower cross-bar 20 of the push bumper itself, and a cooperating pair of second lower mounting components 104 attached to the mounting frame of the bicycle carrier at the lower ends of the two side members 50 thereof. In the illustrated example, the first lower mounting components 102 are a set of male uprights or lugs attached, for example by welding, to the lower cross-bar of the push bumper to stand upright therefrom at spaced locations therealong near respective ends thereof. The second lower mounting components 104 are a set of female sockets attached to the lower ends of the mounting's frame side members at the lower ends thereof in a downward-opening orientation. Each female socket is finable over a respective male upright to mate the first and lower second components together. In this mated condition of the lower mounting components, a pin hole 104a in each female socket 104 aligns with a respective pin hole 102a in each male upright 102 to enable passage of a respective locking pin 48 through the aligned holes to thereby secure the mounting frame to the lower cross-bar 20 of the push bumper.

In a variant of this embodiment, instead of male mounting components situated on the push bumper and mating female mounting components on the mounting frame of the bicycle carrier, the reverse configuration may alternatively be employed. Though use of mating male and female components aids in properly aligned placement of the mounting frame on the bush bumper to enable to the pinned connection thereto, it will be appreciated that the first and second cooperating mounting components on the push bumper and bicycle carrier need not necessarily be of such cooperatively mating male and female configuration. For example, the lower ends of the side members 50 may have pin holes formed directly therein for alignment with the pin holes 102a in the male uprights or lugs 102 when placed beside same in non-mating relation thereto.

In the FIG. 4 embodiment, releasable attachment of the mounting frame to the upper cross-bar 22 of the push bumper employs a pair of upper mounting components 106 attached to the mounting frame of the bicycle carrier at the upper ends of the two side members 50 thereof. In the illustrated example, these upper mounting components 106 are a pair of movable hooking or clamping members movable into, and lockable or otherwise securable in, a retaining position engaging around the rear side of the push bumper's upper cross-bar 22, as shown in the drawing. The present embodiment thus employs a one-time modification of the push bumper to add one or more mounting components thereto, specifically two lower mounting components on the lower cross-bar in the illustrated example, after which selective installation of the bicycle carrier requires only a pinned connection to one cross-bar of the push bumper, and a simple, quick clamping or hooking engagement with the push bumper's other cross member. In another variant, the same type of pinned connection at the lower cross-bar may also be used at the upper cross bar. This type of pinned connection in the second illustrated embodiment, versus the U-channel pinned connection of the first embodiment, avoids the complication that the cross-bars of different models of push bumper may be of different size and cross-sectional shape not universally compatible with a standardized size of channe-shaped mount.

Finally, the second embodiment also differs from the first in that the clam-shell bicycle holder is replaced with a pair of bicycle cradles 108 of the type shown in U.S. Design Pat. No. D647,452 by Thule Sweden, the entirety of which is incorporated herein by reference. A base 110 of each cradle has a through-bore therein through which a respective arm 56 of the carrier frame extends to mount the cradle thereon near the distal end thereof. A U-shaped cradle seat 112 opens upwardly from the base to receive the top tube of the bicycle therein. On opposing outer sides of the cradle seat112, a pair of strap lugs 114 are provided to enable engagement of a securement strap 116 to the strap lugs 114 in a position spanning over the topside of the bicycle's top tube to prevent the bicycle escaping the cradles during transport, even during travel over bumpy or rough terrain.

Since various modifications can be made in my invention as herein above described, and many apparently widely different embodiments of same made, it is intended that all matter contained in the accompanying specification shall be interpreted as illustrative only and not in a limiting sense.

1. A bicycle carrier configured to mount on a push bumper of a vehicle.

2. The bicycle carrier of claim 1 configured to mount on the push bumper at one or more cross-bars thereof.

3. The bicycle carrier of claim 2 configured to mount on the push bumper at a pair of vertically-spaced cross-bars thereof.

4. The bicycle carrier claim 1 comprising a mounting frame configured to mount to the push bumper, and a carrier frame disposed in or movable into a working state reaching outwardly from said mounting frame to support a bicycle on the carrier frame in front of the push bumper.

5. The bicycle carrier of claim 4 wherein the mounting frame comprises at least one member having an upper end equipped with an upper mounting component engageable to an upper cross-bar of the push bumper to support said at least one member in a position spanning downwardly therefrom toward a lower cross-bar of the push bumper.

6. The bicycle carrier of claim 5 wherein said at least one member of the mounting frame comprises two members, each equipped with a respective upper mounting component engageable to the upper cross-bar of the push bumper.

7. The bicycle carrier of claim 5 wherein the carrier frame comprises an arm reaching forwardly from the member of the mounting frame proximate the upper end thereof.

8. The bicycle carrier of claim 6 wherein the carrier frame comprises a pair of arms reaching respectively forward from the two members of the mounting frame proximate the upper ends thereof.

9. A vehicle push bumper having a bicycle carrier supported thereon to indirectly support said bicycle carrier on a vehicle.

10. The push bumper of claim 9 wherein the bicycle carrier is mounted on the push bumper at one or more cross-members thereof.

11. The push bumper of claim 10 wherein the bicycle carrier is mounted on the push bumper at two vertically-spaced cross-members thereof.

12. The push bumper of claim 9 wherein the bicycle carrier comprises a mounting frame mounted to the push bumper, and a carrier frame disposed in or movable into a working state reaching outwardly from said mounting frame to support a bicycle on the carrier frame in front of the push bumper.

13. The push bumper of claim 12 wherein the mounting frame comprises at least one member having an upper end equipped with an upper mounting component engaged to an upper cross-bar of the push bumper to support said at least one member in a position spanning downwardly therefrom toward a lower cross-bar of the push bumper.

14. The push bumper of claim 13 wherein said at least one member of the mounting frame comprises two members, each equipped with a respective upper mounting component engaged to the upper cross-bar of the push bumper.

15. The push bumper of claim 13 wherein the carrier frame comprises an arm reaching forwardly from the member of the mounting frame proximate the upper end thereof.

16. The push bumper of claim 14 wherein the carrier frame comprises a pair of arms reaching respectively forward from the two members of the mounting frame proximate the upper ends thereof.

17. The push bumper of claim 9 in combination with said vehicle, wherein the push bumper is in an installed state on said vehicle and indirectly supports the bicycle carrier on said vehicle.

18. The push bumper of claim 9 wherein the bicycle carrier is removably mounted to said push bumper.

19. A method of installing a bicycle carrier on a vehicle, said method comprising mounting said bicycle carrier to a push bumper of said vehicle.

20. The method of claim 19 comprising, removably mounting said bicycle carrier to the push bumper, and between uses of said bicycle carrier, storing said bicycle carrier in a trunk, hatch, cargo bed or other cargo space of the vehicle.
